(19) United States
(12) Patent Application Publication
(10) Pub. No.: US 2025/0267588 A1
(43) Pub. Date: Aug. 21, 2025

(54) METHODS, COMMUNICATIONS DEVICES, AND INFRASTRUCTURE EQUIPMENT

(71) Applicant: Sony Group Corporation, Tokyo (JP)

(72) Inventor: Shin Horng WONG, Basingstoke (GB)

(73) Assignee: Sony Group Corporation, Tokyo (JP)

(21) Appl. No.: 18/857,187

(22) PCT Filed: Mar. 30, 2023
(86) PCT No.: PCT/EP2023/058304

§ 371 Date: Oct. 16, 2024

(30) Foreign Application Priority Data
Apr. 28, 2022 (EP) 22170648.4

(51) Int. Cl. H04W 52/14; H04W 52/36; H04W 76/20

(52) U.S. Cl. CPC H04W 52/146; H04W 52/36; H04W 76/20

(57) ABSTRACT

A method for operating a communications device in a wireless network is provided. The device transmits and receives signals via a wireless radio interface. The method involves determining the need for an uplink transmission within allocated uplink resources. It further includes selecting a non-uniform transmission power across these resources, using different power levels for different portions. Specifically, the device applies a first transmission power to a first portion of the uplink resources and a second, distinct power to a second portion. The uplink transmission is then performed according to this non-uniform power scheme.

### BACKGROUND

### Field of Disclosure

The present disclosure relates to communications devices, infrastructure equipment and methods for the more robust communication of data in a wireless communications network.

The present application claims the Paris Convention priority from European Patent Application number EP22170648.4, filed on 28 Apr. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current agenda includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises determining that the communications device is to perform an uplink transmission to the wireless communications network within an allocated set of uplink resources of the wireless radio interface, determining that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and performing the uplink transmission to the wireless communications network within the set of uplink resources in accordance with the non-uniform transmission power.

Embodiments of the present technique, which, in addition to methods of operating communications devices, relate to communications devices, infrastructure equipment, methods for operating such infrastructure equipment, circuitry for such communications devices and infrastructure equipment, wireless communications systems, computer programs, and non-transitory computer-readable storage mediums, allow for the more robust communication of data in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference;

FIG. 5 illustrates an example approach for accounting for inter-cell cross link interference;

FIG. 6 schematically illustrates an example of intra-cell cross link interference;

FIG. 7 illustrates an example division of system bandwidth into dedicated uplink and downlink sub-bands;

FIG. 8 illustrates an example of transmission power leakage;

FIG. 9 illustrates an example of receiver power selectivity;

FIG. 10 illustrates adjacent channel interference;

FIG. 11 shows a flow diagram illustrating a first example process of communications in a communications system in accordance with embodiments of the present technique;

FIG. 12 shows an example of non-uniform power control in accordance with embodiments of the present technique;

FIG. 13 shows an example of how a non-uniform power control function may be defined relative to a reference power in accordance with embodiments of the present technique;

FIG. 14 shows an example of how a non-uniform power control function may be configured for each sub-band of a wireless radio interface in accordance with embodiments of the present technique;

FIG. 15 shows an example of how a non-uniform power control function may be configured for each transmission in accordance with embodiments of the present technique;

FIG. 16 illustrates an example of how a non-uniform power control indicator may define a non-uniform power control function in accordance with embodiments of the present technique;

FIG. 17 shows an example of how group common downlink control information (GC-DCI) can indicate for which of a plurality of sub-bands of a wireless radio interface non-uniform power control needs to be applied in accordance with embodiments of the present technique; and

FIG. 18 shows a flow diagram illustrating a second example process of communications in a communications system in accordance with embodiments of the present technique.

### DETAILED DESCRIPTION OF THE EMBODIMENTS

### Long Term Evolution Advanced Radio Access Technology (4G)

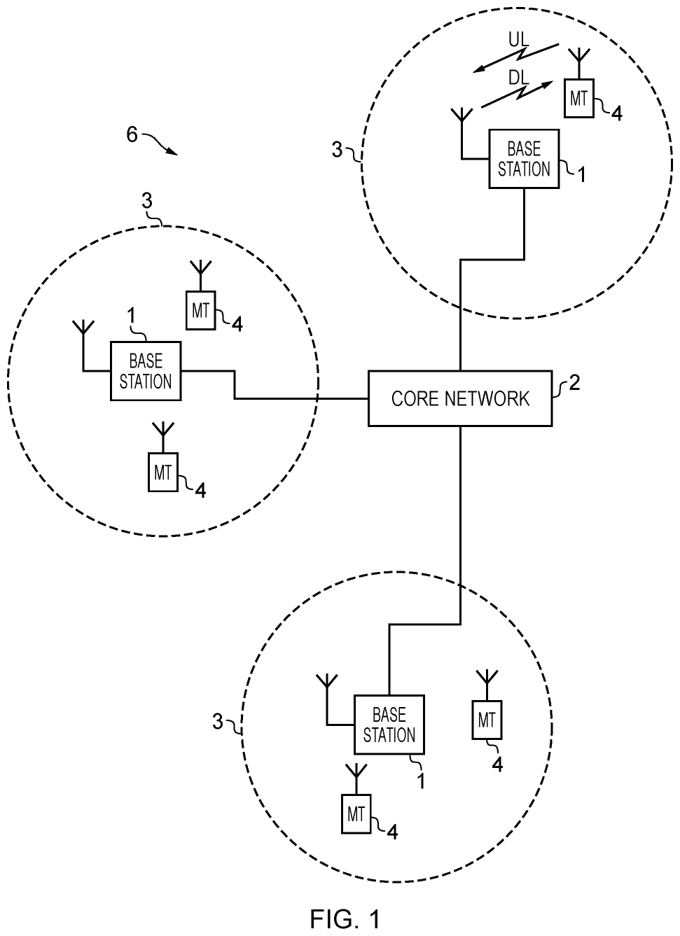

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL. Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

3GPP has completed the basic version of 5G in Rel-15, known as the New Radio Access Technology (NR). In addition, enhancements have been made in Rel-16, incorporating new features such as the 2-step RACH procedure [2], Industrial Internet of Things (IIoT) [3] and NR-based Access to Unlicensed Spectrum (NR-U) [4].

The NR radio access system employs Orthogonal Frequency Division Multiple Access (OFDMA), where different users are scheduled in different subsets of sub-carriers simultaneously. However, OFDMA requires tight synchronisation in the uplink transmissions in order to achieve orthogonality of transmissions from different users. In essence, the uplink transmissions from all users must arrive at the same time (i.e. they must be synchronised) at the gNB receiver. A UE that is far from the gNB must therefore transmit earlier than a UE closer to the gNB, due to different RF propagation delays. In NR, timing advance commands are applied to control the uplink transmission timing for individual UEs, mainly for Physical Uplink Shared Channels (PUSCHs), Physical Uplink Control Channels (PUCCHs) and Sounding Reference Signals (SRS). The timing advance usually comprises twice the one-way propagation delay between the UE and gNB, thus representing both downlink and uplink delays.

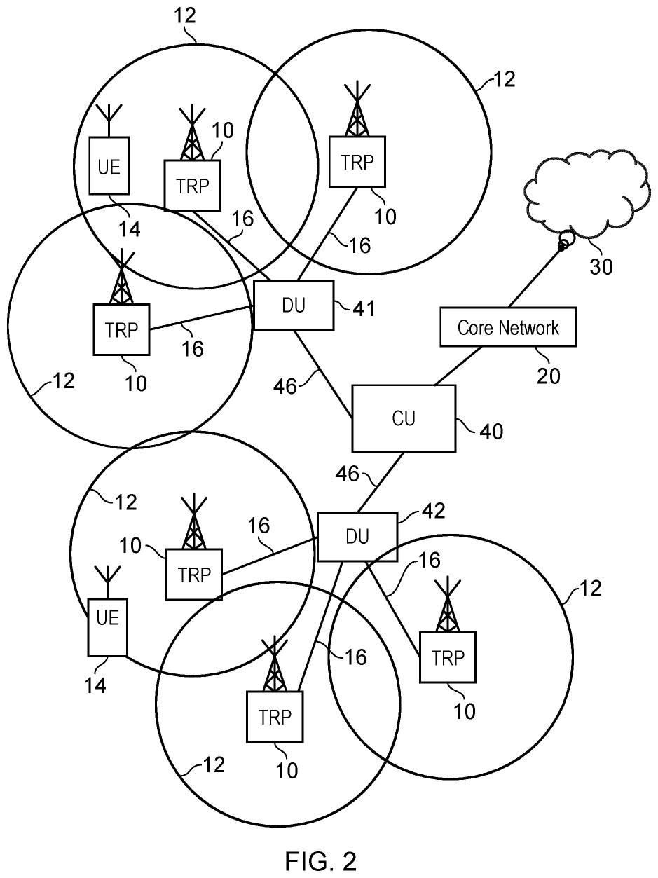

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface (i.e. a radio interface for wireless access) within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

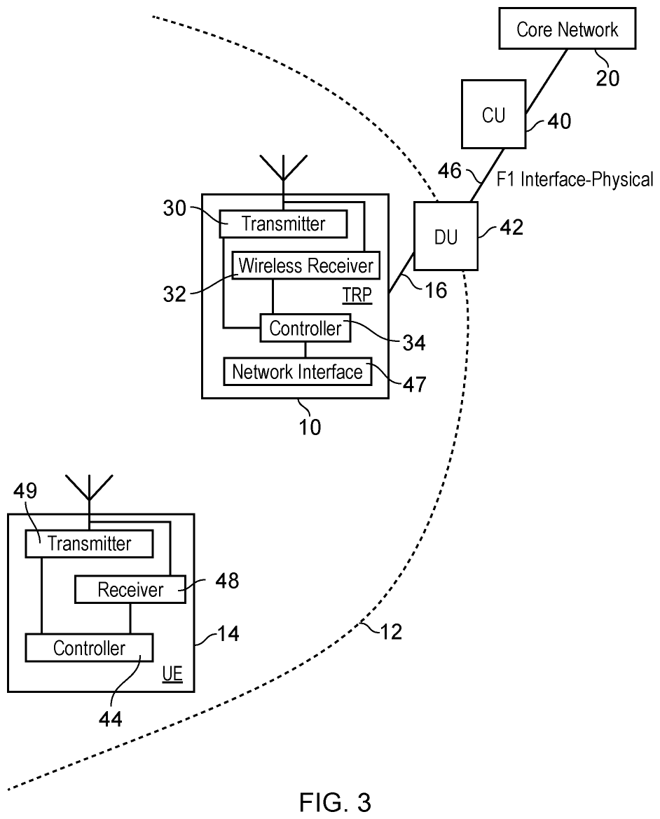

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 45, a receiver 48 and a controller 44 which is configured to control the transmitter 45 and the receiver 48 to transmit signals representing uplink (UL) data to the wireless communications network via the wireless access interface formed by the TRP 10 and to receive downlink (DL) data as signals transmitted by the transmitter 30 and received by the receiver 48 in accordance with the conventional operation.

The transmitters 30, 45 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 47 which connects to the DU 42 via a physical interface 16. The network interface 47 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 47 of the TRP 10 to the DU 42 and the F1 interface 46 from the DU 42 to the CU 40.

### Full Duplex Time Division Duplex (FD-TDD)

NR/5G networks can operate using Time Division Duplexing (TDD), where an entire frequency band is switched to either downlink or uplink transmissions for a time period and can be switched to the other of downlink or uplink transmissions at a later time period. Currently, TDD operates in Half Duplex mode (HD-TDD), where the gNB or UE can, at a given time, either transmit or receive packets, but not both at the same time.

As wireless networks transition from NR to 5G-Advanced networks, a proposed new feature of such networks is to enhance duplexing operation for Time Division Multiplexing (TDD) by enabling Full Duplex operation in TDD (FD-TDD) [5]. In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission to a second UE within the same OFDM symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD, development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, slots are allocated only for either an DL or UL direction in a semi-static manner. Hence, if one direction experiences less or no data, the spare resources cannot be used in the other direction, or are, at best, under-utilized. However, if resources can be used for either DL data or UL data (as in FD-TDD), the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

With respect to [5] in relation to FD-TDD operation in Rel-18, it is expected that 3GPP will consider only HD-TDD UEs operating together with a FD-TDD gNB. This allows legacy TDD UEs that are Half Duplex to benefit from the FD-TDD operation, which enables complexity to be reduced at the UE to operate in a FD-TDD gNB, and furthermore enables the faster introduction of FD-TDD into the market.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI. Flexible OFDM Symbols that remain Flexible after instruction from the SFI can be changed to a DL symbol or a UL symbol by a DL Grant or a UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

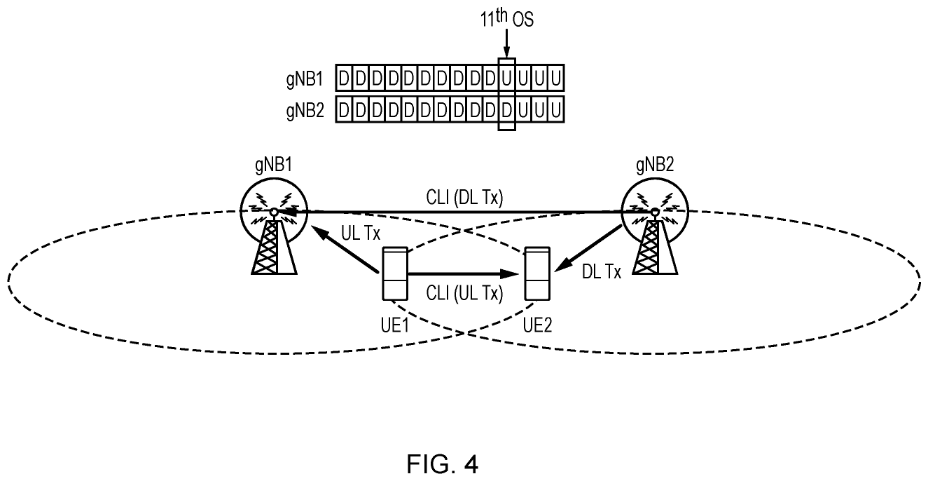

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs. Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 and gNB2 have synchronised slots. At a given slot, gNB1's slot format={D, D, D, D, D, D, D, D, D, D, U, U, U, U} whilst gNB2 #s slot format={D, D, D, D, D, D, D, D, D, D, D, U, U, U}, where ‘D’ indicates DL and ‘U’ indicates UL. Inter-cell CLI occurs during the 11^{th} OFDM symbol of the slot, where gNB1 is performing UL whilst gNB2 is performing DL. Specifically, inter-cell CLI occurs between gNB1 & gNB2, where gNB2's DL transmission interferes with gNB1's UL reception. CLI also occurs between UE1 & UE2, where UE1's UL transmission interferes with UE2's DL reception.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). For SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

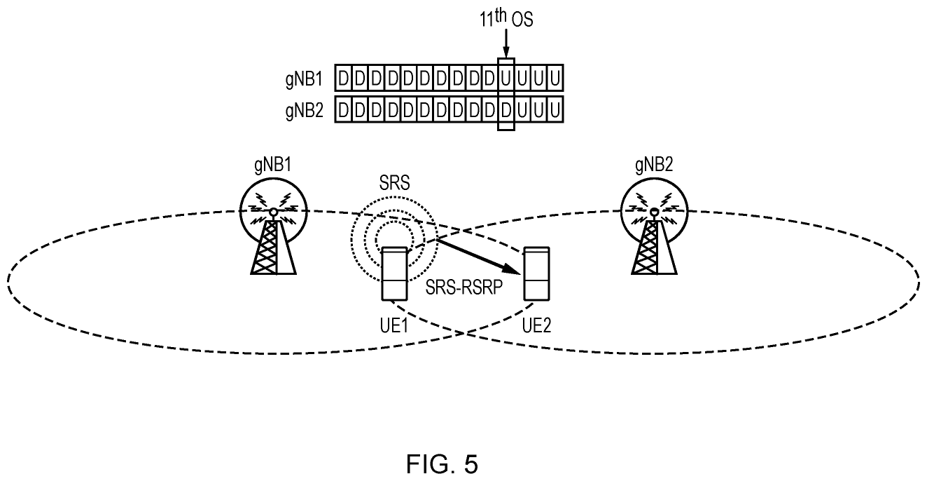

Both SRS-RSRP and CLI-RSSI are RRC measurements are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11th OS of gNB1 and gNB2 causes inter-cell CLI. Here, gNB1 has configured UE1, the aggressor UE, to transmit an SRS and gNB2 has configured UE2, the victim UE, to measure that SRS. UE2 is provided with UE1's SRS configured parameters, e.g. RS sequence used, frequency resource, frequency transmission comb structure & time resources, so that UE2 can measure the SRS. In general, a UE can be configured to monitor 32 different SRSs, at a maximum rate of 8 SRSs per slot.

For CLI-RSSI measurements, the UE measures the total received power, i.e. signal and interference, following a configured periodicity, start & end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI that may be expected to be experienced by the victim UE.

### Uplink Power Control

The existing UL power control P_{UL} (in dBm) is described in [6] as follows:

$${P}_{UL} = min \{ {P}_{CMAX} , {P}_{O} + α \cdot PL + 10 \cdot {log}_{10} ( {2}^{μ} \cdot {M}_{RB} ) + {Δ}_{TF} + δ$$

### Where,

P_{CMAX} is the configured maximum transmit power that the UE is allowed to use;
P_{O} is an RRC parameter configured by the network, which is the estimated target received power at the gNB;
α is a fractional path loss and is RRC configured by the network;
PL is the UE estimated path loss between the gNB and the UE;
μ is the factor determining the subcarrier spacing (SCS), where SCS=2^{μ}·15 kHz;
M_{RB} is the number of RBs scheduled for the UL transmissions;
Δ_{TF} is a factor dependent upon the MCS used for the UL transmission; and
δ is the close-loop power adjustment indicated by the TPC command.

The current power control scheme consists of an open loop component P_{O}+α. PL and a close loop component δ, where the total amount of power is scaled according to the number of RBs and MCS used which is determined in the parameters 10·log₁₀(2^{μ}·M_{RB}) and Δ_{TF} respectively. The UE is restricted to a maximum power of P_{CMAX} which is RRC configured by the network. The power is transmitted uniformly across all the scheduled M_{RB} RBs.

### Intra-Cell Cross Link Interference (CLI)

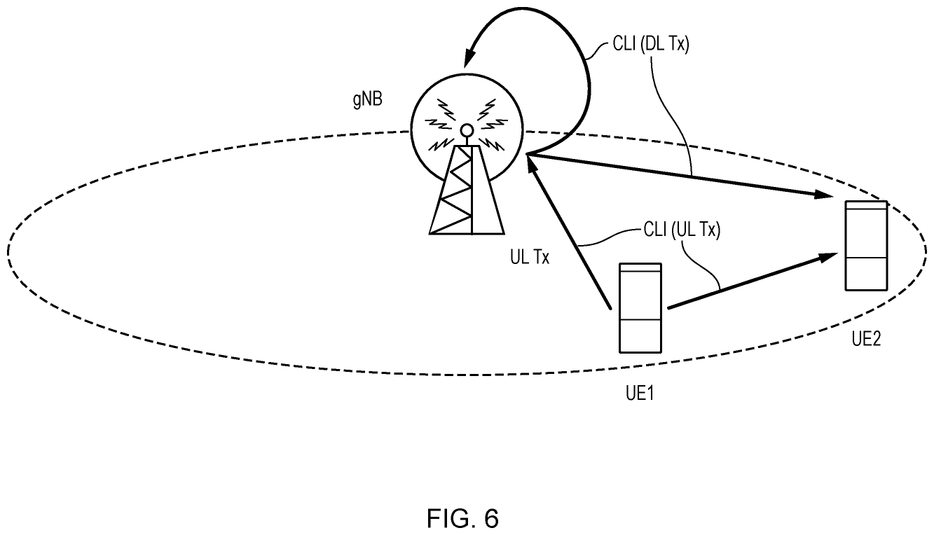

In addition to inter-cell CLI, FD-TDD also suffers from intra-cell CLI at the gNB and at the UE. An example is shown in FIG. 6, where a gNB is capable of FD-TDD and is simultaneously receiving UL transmission from UE1 and transmitting DL transmission to UE2. At gNB1, intra-cell CLI is caused by the DL transmission at the gNB's transmitter self-interfering with its own receiver that is trying to decode UL signals. At the UE, intra-cell CLI is caused by an aggressor UE, e.g. UE1, transmitting in the UL, whilst a victim UE, e.g. UE2, is receiving a DL signal.

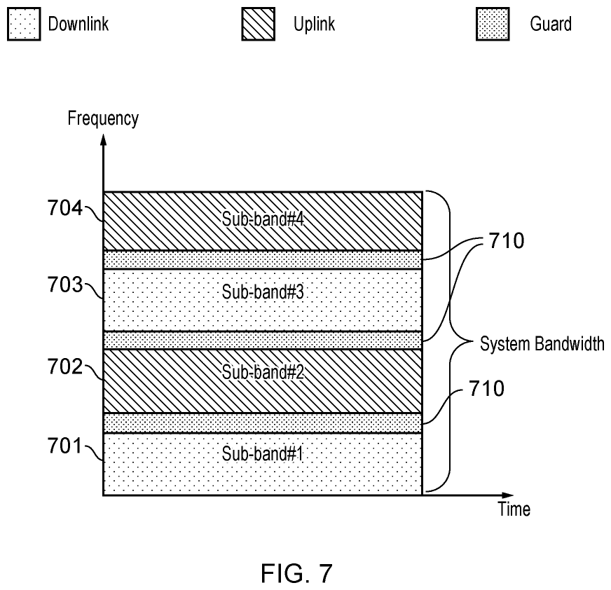

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility is to divide the system (i.e. UE/gNB) bandwidth into non-overlapping sub-bands 701-704, as shown in FIG. 7, where simultaneous DL and UL transmissions occur in different sub-bands 701-704, i.e. in different sets of frequency Resource Blocks (RB).

To reduce leakage from one sub-band 701-704 to another, a guard sub-band 710 may be configured between UL and DL sub-bands 701-704. An example is shown in FIG. 7, where a TDD system bandwidth is divided into 4 sub-bands 701, 702, 703, 704: Sub-band #1 701, Sub-band #2 702, Sub-band #3 703 and Sub-band #4 704 such that Sub-band #1 701 and Sub-band #3 703 are used for DL transmissions, whilst Sub-band #2 702 and Sub-band #4 704 are used for UL transmissions. Guard sub-bands 710 are configured between UL Sub-band #4 704 and DL Sub-band #3 703, between DL Sub-band #3 703 and UL Sub-band #2 702 and between UL Sub-band #2 702 and DL Sub-band #1 701. The arrangement of sub-bands 701-704 shown in FIG. 7 is just one possible arrangement of the sub-bands and other arrangements are possible. For example, such possible arrangements, along with further details on FD-TDD and use of sub-bands may be understood from related documents in the art, such as European patent No. 3545716 [7], the contents of which are hereby incorporated by reference.

### Adjacent Channel Interference (ACI)

Although a transmission is typically scheduled within a specific frequency channel, i.e. a specific set of RBs, transmission power can leak out to other channels. This occurs because channel filters are not perfect, and as such the roll-off of the filter will cause power to leak into channels adjacent to the intended specific frequency channel.

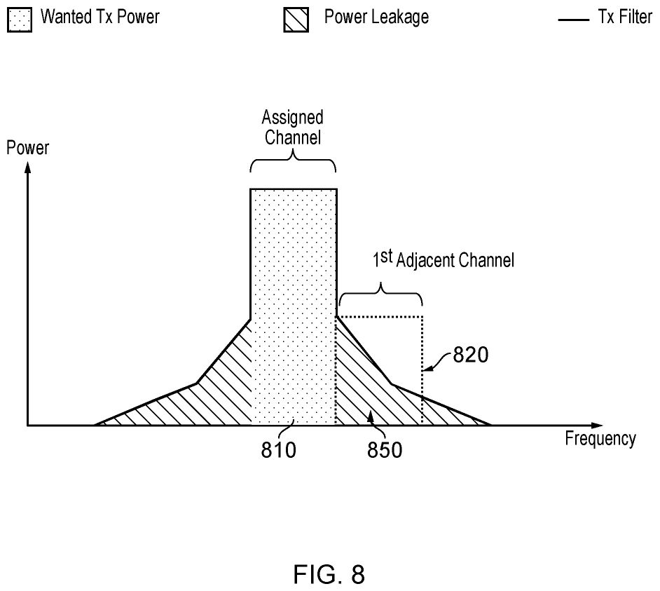

An example of transmission adjacent channel leakage is shown in FIG. 8. Here, the wanted transmission (Tx) power is the transmission power in the selected frequency band (i.e. the assigned channel 810). Due to roll-off of the transmission filter, some transmission power is leaked into adjacent channels (including an adjacent channel 820), as shown in FIG. 8. The ratio of the power within the assigned frequency channel 810 to the power in the adjacent channel 820 is the Adjacent Channel Leakage Ratio (ACLR). The leakage power 850 will cause interference at a receiver that is receiving the signal at the adjacent channels 820.

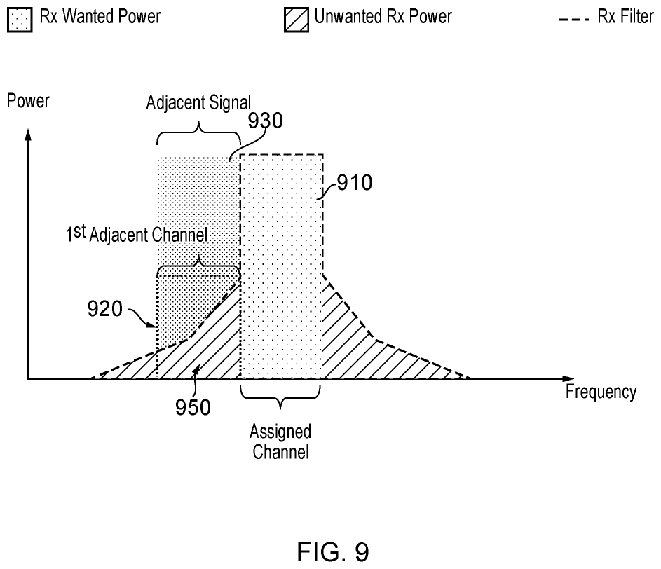

Similarly, a receiver's filter is also not perfect and will receive unwanted power from adjacent channels due to its own filter roll-off. An example of filter roll-off at a receiver is shown in FIG. 9. Here, a receiver is configured to receive transmissions in an assigned channel 910, however the imperfect nature of the receiver filter means that some transmission power 950 can be received in an adjacent channel 920. Therefore, if a signal 930 is transmitted on an adjacent channel 920, the receiver will inadvertently receive the adjacent signal 930 in the adjacent channel 920, to an extent. The ratio of the received power in the assigned frequency channel 910 to the received power 950 in the adjacent channel 920 is the Adjacent Channel Selectivity (ACS).

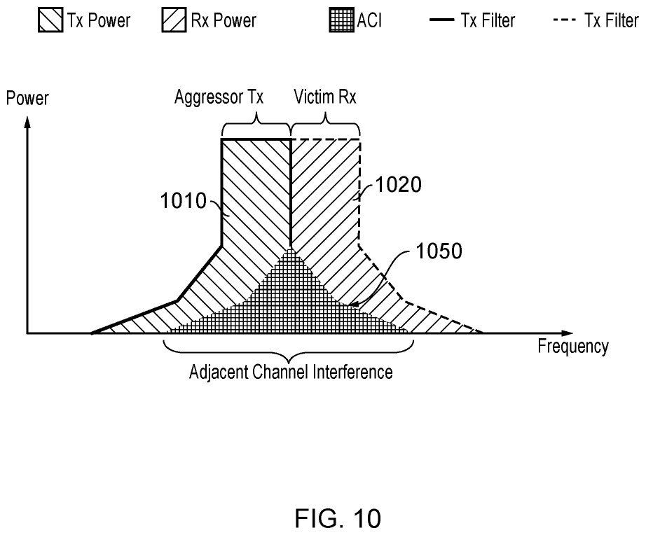

The combination of the ACL from the transmitter and the ACS of a receiver will lead to adjacent channel interference (ACI) at the receiver. An example is shown in FIG. 10, where an aggressor transmits a signal 1010 in an adjacent channel at a lower frequency than the victim's receiving 1020 channel. The interference 1050 caused by the aggressor's transmission includes the ACL of the aggressor's transmitting filter and the ACS of the victim's receiving filter. In other words, the receiver will experience interference 1050 in the ACI frequency range shown in FIG. 10.

As such, due to adjacent channel interference (ACI), cross link interference (CLI) will still occur despite the use of different sub-bands 701-704 for DL and UL transmissions in a FD-TDD cell, even in cases where these sub-bands 701-704 do not overlap. Hence, new methods are required to manage ACI in FD-TDD employing sub-bands. Embodiments of the present disclosure seek to provide such methods.

### Non-Uniform Power Control for FD-TDD

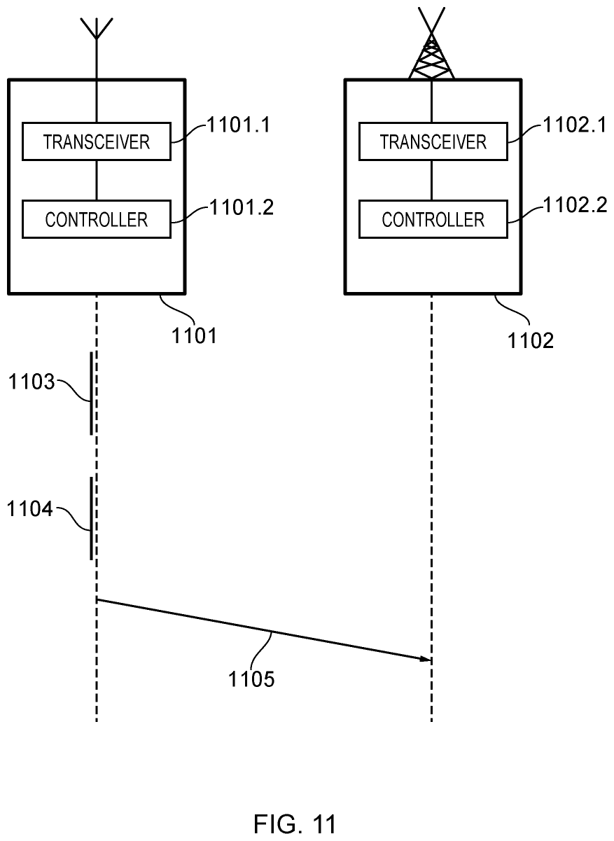

FIG. 11 shows a part schematic, part message flow diagram representation of a first wireless communications system comprising a communications device 1101 and an infrastructure equipment 1102 in accordance with at least some embodiments of the present technique. The communications device 1101 is configured to transmit signals to and/or receive signals from the wireless communications network, for example, to and from the infrastructure equipment 1102. Specifically, the communications device 1101 may be configured to transmit data to and/or receive data from the wireless communications network (e.g. to/from the infrastructure equipment 1102) via a wireless radio interface provided by the wireless communications network (e.g. a Uu interface between the communications device 1101 and the Radio Access Network (RAN), which includes the infrastructure equipment 1102). The communications device 1101 and the infrastructure equipment 1102 each comprise a transceiver (or transceiver circuitry) 1101.1, 1102.1, and a controller (or controller circuitry) 1101.2, 1102.2. Each of the controllers 1101.2, 1102.2 may be, for example, a microprocessor, a CPU, or a dedicated chipset, etc.

As shown in the example of FIG. 11, the transceiver circuitry 1101.1 and the controller circuitry 1101.2 of the communications device 1101 are configured in combination to determine 1103 that the communications device 1101 is to perform an uplink transmission to the wireless communications network (e.g. to the infrastructure equipment 1102) within an allocated set of uplink resources of the wireless radio interface, to determine 1104 that the communications device 1101 is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and to perform 1105 the uplink transmission to the wireless communications network (e.g. to the infrastructure equipment 1102) within the set of uplink resources in accordance with the non-uniform transmission power.

Here, the first transmission power may be lower than the second transmission power, and the first portion of the set of uplink resources (i.e. that to which the first transmission power is applied) may comprise one or more frequency resource units (e.g. RBs) located at a first edge of the set of uplink resources and the second portion of the set of uplink resources (i.e. that to which the second transmission power) is applied may comprise one or more frequency resource units (e.g. RBs) located away from the first edge of the set of uplink resources. Those skilled in the art would however appreciate that there may be more than two different transmission power levels, and that the lowest transmission level may not necessarily be applied to those RBs (or other frequency resource units) at the first edge (or indeed either edge or both edges) of the frequency range of the set of uplink resources.

In at least some arrangements of embodiments of the present disclosure, the first edge of the set of uplink resources may be adjacent in frequency to a second set of resources of the wireless radio interface, where the set of uplink resources and the second set of resources may at least partially overlap in time. Here, the second set of resources may be a set of downlink resources of the wireless access interface which is allocated to a second communications device for receiving a downlink signal from the same infrastructure equipment 1102 of the wireless communications network as is the target of the uplink transmission from the communications device 1101 (or indeed a second set of uplink resources of the wireless access interface which is allocated to the second communications device for transmitting a second uplink signal to the same infrastructure equipment 1102), wherein the transmission of the downlink signal (or indeed reception of the second uplink signal) at the infrastructure equipment 1102 may at least partially overlap in time with the reception of the uplink transmission at the infrastructure equipment 1102. Those skilled in the art would appreciate that in at least some implementations of such arrangements, a guard band may separate the set of uplink resource and the adjacent second set of (downlink or uplink resources), in order to mitigate interference from the two sets of resources affecting the transmissions within them. In other words, a third set of resources may be located in frequency between the second set of resources and the set of uplink resources, wherein the third set of resources acts as a guard frequency band.

Essentially, embodiments of the present technique propose that non-uniform power control may be enabled for uplink (and indeed in some cases, downlink) transmissions. Since ACI between sub-bands causes intra-cell CLI as described above, by controlling the power of an uplink transmission, for example such that one or more frequency units (such RBs) closer to an adjacent sub-band are transmitted at lower power compared to RBs further away from the adjacent sub-band, the ACI from the uplink transmission into an adjacent sub-band would therefore be reduced, which would lead to reduced intra-cell CLI.

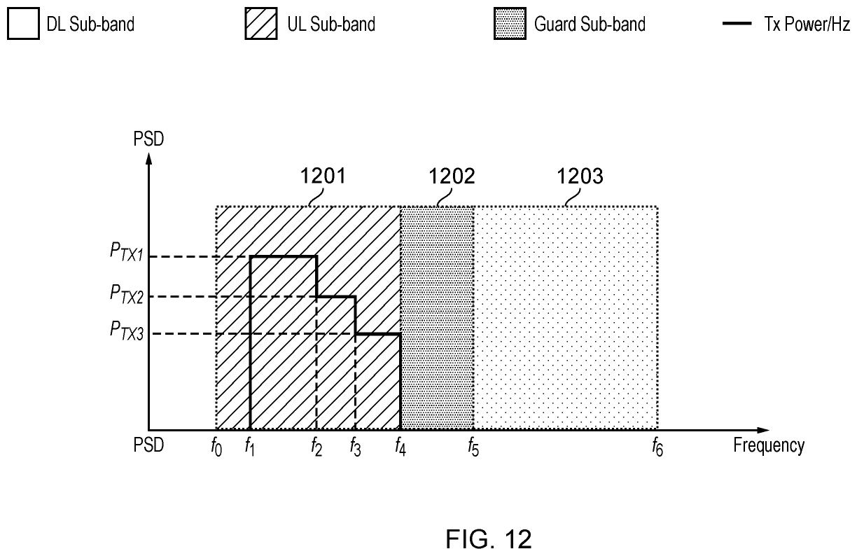

An example of such non-uniform power control in accordance with at least some arrangements of embodiments of the present technique is shown in FIG. 12, where the system bandwidth is divided into three sub-bands; a UL sub-band 1201 from f₀ to f₄, a guard sub-band 1202 from f₄ to f₅, and a DL sub-band 1203 f₅ to f₆. An uplink transmission (e.g. a PUSCH) is scheduled for a UE, occupying frequency range f₁ to f₄ in the UL sub-band 1201. Through application of arrangements of the present technique, the transmission power applied to the uplink transmission in the example of FIG. 12 is non-uniform, where the RBs furthest away from the DL sub-band 1203 (i.e. those in frequency range f₁ to f₂) are transmitted at the highest power at P_{TX1} per Hz, the RBs in frequency range f₂ to f₃ that are closer (than those in frequency range f₁ to f₂) to the DL sub-band 1203 are at transmitted at a lower power at P_{TX2} per Hz, and those RBs closest to the DL sub-band 1203 (i.e. those in frequency range f₃ to f₄) are transmitted at the lowest power of P_{TX3} per Hz. Although three different power levels are used for an uplink transmission in the example in FIG. 12, those skilled in the art would appreciate that this is just an example, and that of course other implementations of non-uniform power control can be used, for example a gradual power reduction instead of a three-step function as that shown in FIG. 12.

In some arrangements of embodiments of the present technique, if non-uniform power control is enabled, one or more power control functions are used by the UE to determine the non-uniform power distribution for its uplink transmission. In other words, the non-uniform transmission power may be determined by the communications device based on a power control function selected by the communications device from among one or more power control functions. This power control function P_{Ctrl}(f), would tell the UE the amount of power to transmit at a specific frequency f.

For cases where more than one power control function is configured, e.g. P1_{Ctrl}(f), P2_{Ctrl}(f), P3_{Ctrl}(f), etc, the network may indicate which power control function to use for an UL transmission. In other words, the selected power control function may be selected by the communications device from among the one or more power control functions based on the communications device receiving an indication of the selected power control function from the wireless communications network.

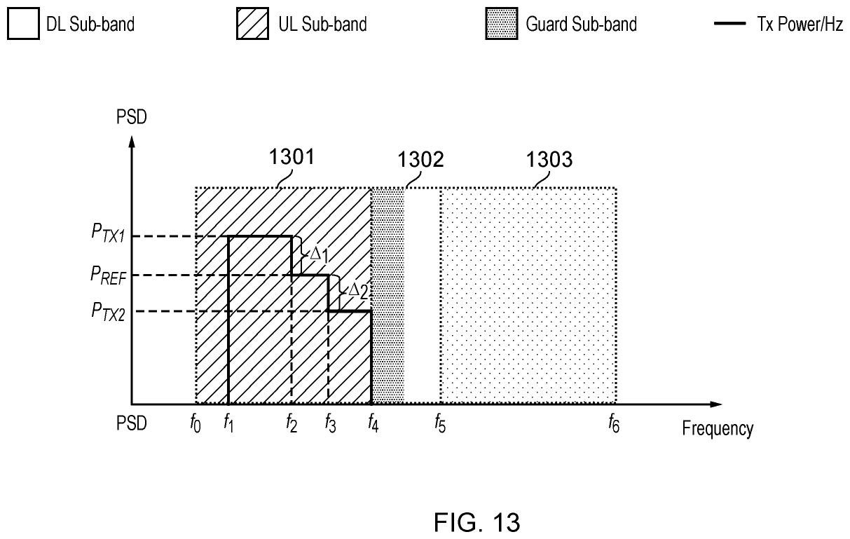

In some arrangements of embodiments of the present technique, the power control function, P_{Ctrl}(f) is a power offset relative to a reference power P_{REF} or a reference Power Spectral Density (PSD), i.e. the actual transmit power for a specific frequency range is P_{REF}+P_{Ctrl}(f). In other words, the one or more power control functions may each be defined as relative to a reference power known to the communications device. An example is shown in FIG. 13, where the UE is scheduled a PUSCH between f₁ to f₄ within an UL sub-band 1301 (which is separated from an adjacent DL sub-band 1303 by a guard band 1302) and the power offset determined by the power control function P_{Ctrl}(f) is:

$${P}_{Ctrl} ( f ) = \{ \begin{matrix}{Δ}_{1} , & {f}_{0} \leq f < {f}_{2} \\ 0 , & {f}_{2} \leq f < {f}_{3} \\ - {Δ}_{2} & {f}_{3} \leq f \leq {f}_{4}\end{matrix}$$

Hence, using this power control function P_{Ctrl}(f), the PSD between f₁ to f₂ is P_{TX1}=P_{REF}+41, between f₂ to f₃ is P_{REF} and between f₃ to f₄ is P_{TX2}=P_{REF}−Δ₂. It should be noted here that, in the example of FIG. 13, the reference power P_{REF} is expressed as a Power Spectral Density (PSD). As those skilled in the art would appreciate however, such arrangements as described with respect to the example of FIG. 13 may be equally applicable for P_{REF} in power, dBm.

In some arrangements of embodiments of the present technique, the said reference power P_{REF} is a determined from the legacy UL power P_{UL} that is described above with reference to [6]. In other words, the reference power may be associated with a known uplink power control function which is defined in the 3GPP specifications. For example, if P_{REF} is expressed in power (dBm), then P_{REF}=P_{UL}. For the case where P_{REF} is a PSD, then P_{REF}=P_{UL}−10·log₁₀(2^{μ}·M_{RB}).

In some arrangements of embodiments of the present technique, the frequency fin the power control function P_{Ctrl}(f) is in units of Resource Blocks RBs. In other words, the one or more power control functions each define, for a range of frequencies, a power level which is to be applied to a frequency resource unit within that range of frequencies, where here, the frequency resource units are resource blocks.

In some other arrangements of embodiments of the present technique, the frequency f in the power control function P_{Ctrl}(f) is in units of subcarriers, where there are 12 subcarriers in an RB. In other words, the one or more power control functions each define, for a range of frequencies, a power level which is to be applied to a frequency resource unit within that range of frequencies, where here, the frequency resource units are subcarriers.

In some arrangements of embodiments of the present technique the said one or more power control functions are based upon the sub-band configuration, that is, each sub-band is configured with a power control function. In other words, each of the one or more power control functions may be associated with one of a plurality of frequency-divided sub-bands of the wireless radio interface, and wherein the selected power control function may be selected by the communications device from among the one or more power control functions based on the one of the plurality of sub-bands which comprises the allocated set of uplink resources. Such arrangements recognise that the determination as to whether UL transmission power needs to be reduced or not may depend on whether there is an adjacent DL sub-band to the UL sub-band containing the UL transmission, and that the level of power reduction to be applied to (the portion(s) of the UL transmission) may depend on the width of the guard sub-band.

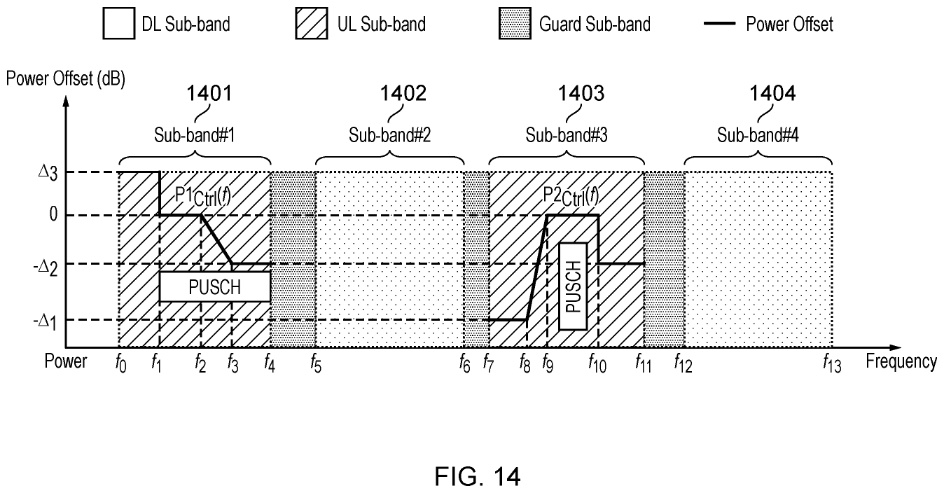

An example is shown in FIG. 14, where the TDD bandwidth f₀ to f₁₃ is divided into four sub-bands, Sub-band #1 1401, Sub-band #2 1402, Sub-band #3 1403, and Sub-band #4 1401. Sub-band #1 1401 and Sub-band #3 1403 are UL sub-bands, while Sub-band #2 1402 and Sub-band #4 1404 are DL sub-bands. As per such arrangements, power control functions P1_{Ctrl}(f) and P2_{Ctrl}(f) are configured for Sub-band #1 1401 and Sub-band #3 1403 respectively, as shown in the example of FIG. 14. Only one side of Sub-band #1 1401 (i.e. the side closer to frequency f₄ than the side closer to frequency f₀) is adjacent to DL Sub-band #2 1402 and hence, it is possible to increase the UE transmit power by Δ₃ at the edge of the system bandwidth, i.e. between f₀ to f₁. Closer to the other edge, that is adjacent to DL Sub-band #2 1402, the power offset is reduced first to 0 dB between f₁ to f₂ then gradually reduced further by Δ₂ and then stays at this level until f₄. For P2_{Ctrl}(f) in Sub-band #3 1403, which is adjacent to DL sub-bands (i.e. Sub-band #2 1402 and Sub-band #4 1404) on both sides, a bigger power offset reduction Δ₁, is used between f₁ to f₈ since the guard sub-band between Sub-band #2 1402 and Sub-band #3 1403 is narrower than the guard sub-band between Sub-band #3 1403 and Sub-band #4 1404. The power offset then goes to 0 dB between f₉ and f₁₀ and then drops again by Δ₂ between f₁₀ to f₁₁.

The sub-band based power control function can be RRC configured per sub-band. In other words, the associations between the one or more power control functions and the associated sub-band may be determined by the communications device based on radio resource control, RRC, signalling received from the wireless communications network. The UE will use the power control function based on where, in the frequency domain, its UL transmission is scheduled. Using the example in FIG. 14, for the PUSCH scheduled in Sub-band #1 1401 occupying frequencies f₁ to f₄, the UE would use P1_{Ctrl}(f), where for the transmission between f₁ to f₂, the UE does not apply any power offset. This is then followed by a gradual reduction in power f₂ to f₃, and from f₃ onwards the UE reduces its power by Δ₂. For the PUCCH scheduled in Sub-band #3 1403 between f₀ and f₁₀, the UE does not need to apply any power offset since within those frequency range, P2_{Ctrl}(f)=0 dB.

In some arrangements of embodiments of the present technique, there can be more than one power control function configured per UL sub-band and the UE may determine which one to use based on an indication from the network. In other words, more than one of the power control functions may be associated with a same one of the plurality of sub-bands, where here, when more than one of the power control functions are associated with the one of the plurality of sub-bands which comprises the allocated set of uplink resources, the selected power control function may be selected by the communications device from among the more than one of the power control functions which are associated with the one of the plurality of sub-bands which comprises the allocated set of uplink resources based on the communications device receiving an indication of the selected power control function from the wireless communications network.

In some arrangements of embodiments of the present technique, the said power control functions is based upon the frequency resource scheduled (or configured) for the UL transmission, that is, each UL transmission is provided a P_{Ctrl}(f). In other words, each of the one or more power control functions may be associated with one of a plurality of sets of uplink resources of the wireless radio interface, and wherein the selected power control function may be selected by the communications device from among the one or more power control functions based on the allocated set of uplink resources. This gives the gNB flexibility and finer control over the UL transmissions.

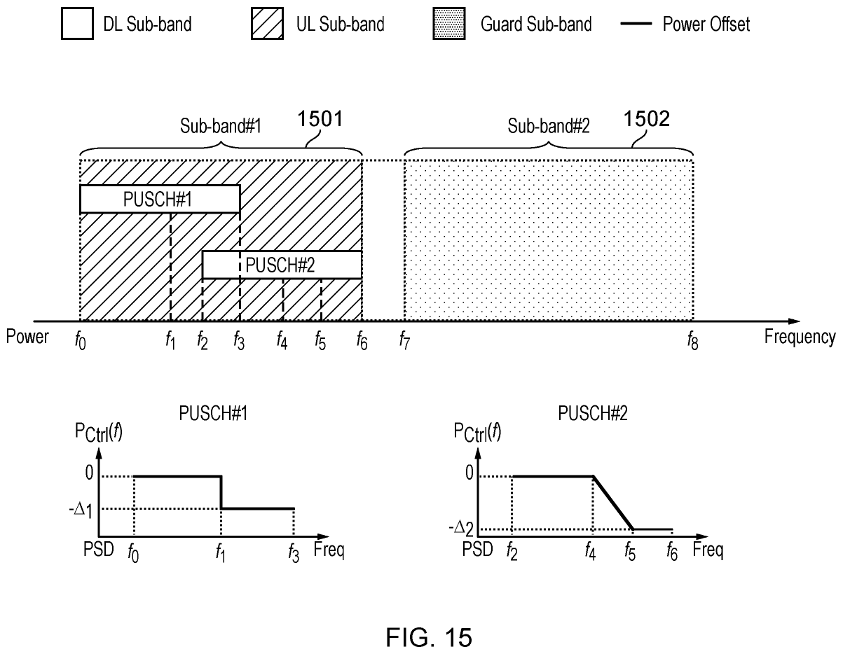

An example is shown in FIG. 15, where the TDD bandwidth f₀ to f₈ is divided into an UL Sub-band #1 1501 occupying f₀ to f₆ and a DL Sub-band #2 1502 occupying f₁ to f₈ with a guard sub-band in between these two sub-bands 1501, 1502. A UE is scheduled PUSCH #1 and PUSCH #2 in different time slots, where PUSCH #1 occupies f₀ to f₃ and PUSCH #2 occupies f₂ to f₆. As per such arrangements, a power control function P_{Ctrl}(f) is used for PUSCH #1 transmission where no power offset is applied for the part of PUSCH #1 occupying f₀ to f₁. However, in the example of FIG. 15, a reduction of Δ₁ is applied for the remaining parts of PUSCH #1 (i.e. from f₁ to f₃). For PUSCH #2 another power control function is used, where here no power offset is applied for the transmission occupying f₂ to f₄, but is followed by a gradual reduction in power from 0 dB to −Δ₂ between f₄ to f₅ and for the rest of the PUSCH #2 (f₅ to f₆) a reduction of 42 dB is used.

In some arrangements of embodiments of the present technique, a power control function is associated with a scheduled (or configured) UL transmission. Here each UL transmission can have a different P_{Ctrl}(f) indicated for the UE to apply to that transmission even if multiple UL transmissions (i.e. from multiple UEs) occupy the same frequency resource. In other words, each of the one or more power control functions may be associated with one of a plurality of uplink transmissions to the wireless communications network, and wherein the selected power control function may be selected by the communications device from among the one or more power control functions based on an indication received by the communications device from the wireless communications network specifically for the uplink transmission performed by the communications device.

In a similar manner to the arrangements of embodiments of the present technique described above with respect to FIG. 14 where the power control function depends on sub-band configuration, in such arrangements of embodiments of the present technique where the power control function depends on the UL transmission frequency resource or scheduled/configured UL transmission, this association may be RRC configured, or multiple power control functions may be configured per frequency resource (where the power control function to use may be dynamically indicated). In other words, the associations between the one or more power control functions and the associated set of uplink resources may be determined by the communications device based on RRC signalling received from the wireless communications network. Alternatively, or in addition, more than one of the power control functions may be associated with a same one of the plurality of sets of uplink resources, where here, when more than one of the power control functions are associated with the allocated set of uplink resources, the selected power control function may be selected by the communications device from among the more than one of the power control functions which are associated with the allocated set of uplink resources based on the communications device receiving an indication of the selected power control function from the wireless communications network.

In some arrangements of embodiments of the present technique, the network indicates a non-uniform power control indicator, to the UE whether to use a non-uniform power control or the legacy, i.e. uniform, power control. In other words, the communications device may be configured to receive, from the wireless communications network, a non-uniform power control indicator, wherein the determining that the communications device is to perform the uplink transmission within the set of uplink resources in accordance with the non-uniform transmission power may be based on determining that the non-uniform power control indicator indicates that the communications device is to perform the uplink transmission within the set of uplink resources in accordance with the non-uniform transmission power. Such arrangements recognise that there may not be any DL transmissions scheduled in a DL sub-band or in RBs close to the edge of a DL sub-band, and hence there is no need to (always) reduce the power of an UL transmission for RBs close to the DL sub-band-thus enabling control by the network as to whether to not non-uniform power control should be applied may be beneficial.

In some arrangements of embodiments of the present technique, the non-uniform power control indicator can indicate one of multiple power control functions, e.g. P1_{Ctrl}(f), P2_{Ctrl}(f), P3_{Ctrl}(f), etc, to use for an UL transmission. In other words, the non-uniform transmission power is determined by the communications device based on a power control function indicated by the non-uniform power control indicator from among a plurality of power control functions. In an implementation, one of the power control functions may indicate the use of uniform power control, i.e. legacy power control.

In some arrangements of embodiments of the present technique, where multiple power control functions are used, the UE may be RRC configured with multiple power control functions, and the non-uniform power control indicator may indicate the index of one of these configured power control functions which is to then be used by the UE. In other words, the plurality of power control functions are indicated in RRC signalling received by the communications device from the wireless communications network, wherein the non-uniform power control indicator indicates one of the power control functions from among the plurality of power control functions indicated by the RRC signalling for use by the communications device.

In some arrangements of embodiments of the present technique, the non-uniform power control indicator provides information of the exact shape of the power control function. In other words, the non-uniform power control indicator may define the non-uniform transmission power. This indication is beneficial for power control functions based on UL transmissions, as the gNB can provide a different P_{Ctrl}(f) which is to some degree tailored for each UL transmission.

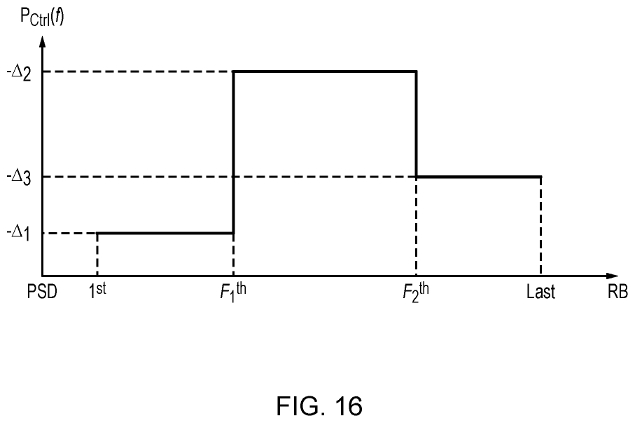

In some implementations of such arrangements, the gNB can signal a set of power offsets and frequencies as shown in the example in FIG. 16, where the indicator consists of three power offsets {Δ₁, Δ₂, Δ₃} and two frequency points {F₁, F₂}. Here, power offset Δ₁ is applied from the 1^{st} RB to the F₁^{th} RB, power offset Δ₂ is applied between the F₁^{th} RB to the F₂^{th} RB and power offset Δ₃ is applied from the F₂^{th} RB to the last RB of the UL transmission. It should be appreciated that is just one example signalling of a power control function and different signalling can be used, e.g. more power offsets points, gradual reduction/increase in power offset, etc.

In some arrangements of embodiments of the present technique, the non-uniform power control indicator is indicated in a DCI, for example in the UL Grant scheduling a PUSCH or the DL Grant scheduling a PUCCH (i.e. that may carry HARQ-ACK feedback for a received PDSCH also scheduled by the DL grant). Here the non-uniform power control indicator may be applicable only to the scheduled PUSCH or PUCCH. In other words, the non-uniform power control indicator is received by the communications device within downlink control information, DCI, transmitted by the wireless communications network, where here, the DCI may be an uplink grant and/or a downlink grant, where the uplink grant and/or the downlink grant may allocate the set of uplink resources in which the communications device is to perform the uplink transmission.

In some other arrangements of embodiments of the present technique, the non-uniform power control indicator may be indicated in an activation DCI of a CG-PUSCH or a SPS. In other words, the non-uniform power control indicator is received by the communications device within downlink control information, DCI, transmitted by the wireless communications network, where here, the DCI may be an activation DCI that indicates that at least one instance of a set of grant-free resources is either activated or deactivated, where the set of grant-free resources may be the allocated set of uplink resources in which the communications device is to perform the uplink transmission to the wireless communications network in a grant-free manner.

In some such arrangements of embodiments of the present technique, where the non-uniform power control indicator is indicated in an activation DCI, the indication may be applicable only to the first X_{PUSCH} CG-PUSCH occasions or to the PUCCH corresponding to the first X_{SPS} SPS PDSCH only. In other words, the non-uniform power control indicator may indicate that the communications device is to perform the uplink transmission within only one or more first instances of the set of grant-free resources in accordance with the non-uniform transmission power. The value of X_{PUSCH} and X_{SPS} can be RRC configured, indicated in the activation DCI, or fixed in the specifications. In some implementations X_{PUSCH}=1 and X_{SPS}=1.

In some arrangements of embodiments of the present technique, the non-uniform power control indicator is indicated in a Group Common DCI (GC-DCI). In other words, the non-uniform power control indicator is received by the communications device within downlink control information, DCI, transmitted by the wireless communications network, where here, the DCI may be a group common DCI, GC-DCI, transmitted by the wireless communications network to one or more other communications devices in addition to the communications device.

In some arrangements of embodiments of the present technique, the GC-DCI may indicate which UL sub-band require the use of non-uniform power control. In other words, the GC-DCI may indicate one or more of a plurality of frequency-divided sub-bands of the wireless radio interface for which the non-uniform transmission power is to be applied, and the communications device may be configured to perform the uplink transmission to the wireless communications network within the set of uplink resources in accordance with the non-uniform transmission power based on the set of uplink resources being within one of the sub-bands for which the GC-DCI indicates the non-uniform transmission power is to be applied.

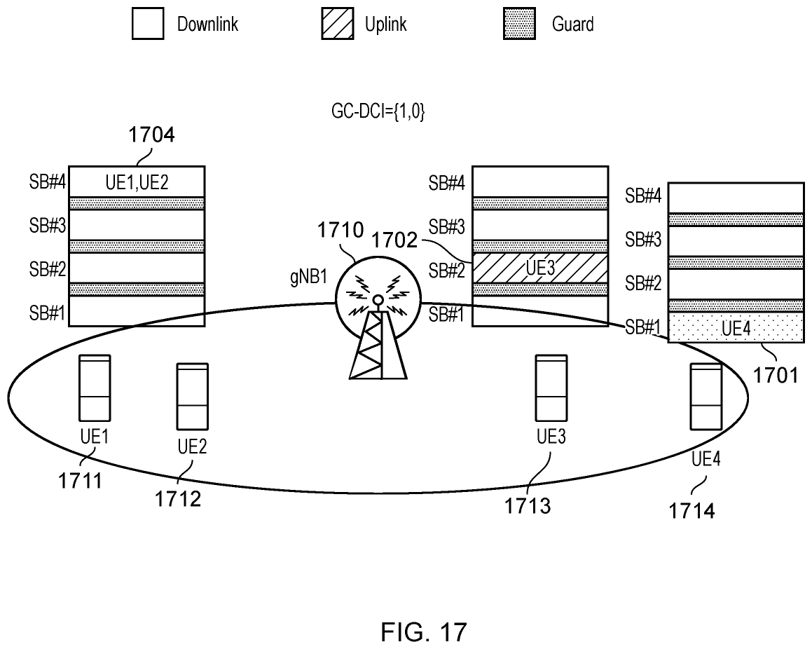

An example is shown in FIG. 17, where the sub-band configuration described in the example system bandwidth division of FIG. 7 is used. Since there are only two UL sub-bands in such a configuration (SB #2 and SB #4), the GC-DCI needs only two bits, where the 1^{st} bit and 2^{nd} bits are associated with UL Sub-band #2 and Sub-band #4 respectively. In the example in FIG. 17, gNB1 1710 schedules UE1 1711 and UE2 1712 for UL transmissions in Sub-band #4 1704, UE3 1713 for UL transmissions in Sub-band #2 1702 and UE4 1714 for DL reception in Sub-band #1 1701. The GC-DCI indicates {1, 0}, i.e. UL transmissions in UL Sub-band #2 1702 need to apply non-uniform power control (because they are adjacent to DL Sub-band #1 1701 in which UE4 1714 is scheduled for DL reception) whilst UL transmissions in Sub-band #4 1704 do not need to apply non-uniform power control since only Sub-band #1 1701 is used for downlink and only UL transmissions in Sub-band #2 1702 (and not Sub-band #4 1704) would cause significant ACI into Sub-band #1 1701. Here, UE1 1711 and UE2 1712 would therefore, as indicated by the GC-DCI, use legacy power control whilst UE3 1713 would apply non-uniform power control.

In some arrangements of embodiments of the present technique, the GC-DCI indicates whether non-uniform power control for transmission in an UL sub-band across time. In other words, the GC-DCI may be associated with one of a plurality of frequency-divided sub-bands of the wireless radio interface and indicates, for that associated sub-band, one or more of a plurality of time-divided slots of the wireless radio interface for which the non-uniform transmission power is to be applied, and the communications device may be configured to perform the uplink transmission to the wireless communications network within the set of uplink resources in accordance with the non-uniform transmission power based on the set of uplink resources being within the sub-band associated with the GC-DCI and within one of the slots, indicated by the GC-DCI, for which the non-uniform transmission power is to be applied. For example, a GC-DCI can use a 14-bit bitmap, where each bit corresponds to an OFDM symbol of a slot and indicates whether non-uniform power control is for that OFDM symbol. It should be appreciated that other bitmap size can be used and each bit in the bitmap can correspond to other units of time resources, e.g. each bit corresponds to a slot or sub-slot.

In some arrangements of embodiments of the present technique, the GC-DCI may comprise a 2D bitmap of N×M dimensions, which corresponds to N UL sub-bands and M time units. In other words, the GC-DCI may indicate a two-dimensional bitmap, the GC-DCI indicating, in a first dimension of the bitmap, one or more of a plurality of frequency-divided sub-bands of the wireless radio interface for which the non-uniform transmission power is to be applied, and the GC-DCI indicating, in a second dimension of the bitmap, one or more of a plurality of time-divided slots of the wireless radio interface for which the non-uniform transmission power is to be applied, where here the communications device may be configured to perform the uplink transmission to the wireless communications network within the set of uplink resources in accordance with the non-uniform transmission power based on the set of uplink resources being within one of the sub-bands, indicated by the GC-DCI, for which the non-uniform transmission power is to be applied and within one of the slots, indicated by the GC-DCI, for which the non-uniform transmission power is to be applied. For example, N=2 and M=5, which addresses 2 UL sub-bands across 5 slots, where in this example the time unit is in slots. Hence if the GC-DCI indicates

$$\{ \begin{matrix}11000 \\ 01001\end{matrix} \} ,$$

it means that any UL transmissions in the 1^{st} UL sub-band in the 1^{st} and 2^{nd} slots need to use non-uniform power control, and any UL transmissions in the 2^{nd} UL sub-band in the 2^{nd} and 5th slots need to use non-uniform power control.

In some arrangements of embodiments of the present technique, each GC-DCI is associated with one UL sub-band where the association is RRC configured. In other words, the communications device may be configured to receive RRC signalling from the wireless communications network, the RRC signalling indicating an association between the GC-DCI and one of a plurality of frequency-divided sub-bands of the wireless radio interface. Here, each GC-DCI may have a different RNTI, for example if there are two UL sub-bands as in the example configuration of FIG. 7, then two GC-DCIs may be configured with different RNTIs such that one RNTI is associated with UL Sub-band #2 and another RNTI is associated with UL Sub-band #4.

In some arrangements of embodiments of the present technique, the determination as to whether or not to use non-uniform power control may be RRC configured. In other words, the non-uniform power control indicator may be received by the communications device via RRC signalling from the wireless communications network. In an implementation, each UL sub-band (for case where multiple UL sub-bands are used) can be configured, e.g. via the RRC signalling, such that the communications device knows whether to apply non-uniform power control or not for that sub-band. For cases where non-uniform power control is to be applied, the network may also RRC configure the one or more power control functions for each UL sub-band in accordance with arrangements of embodiments of the present technique as described above.

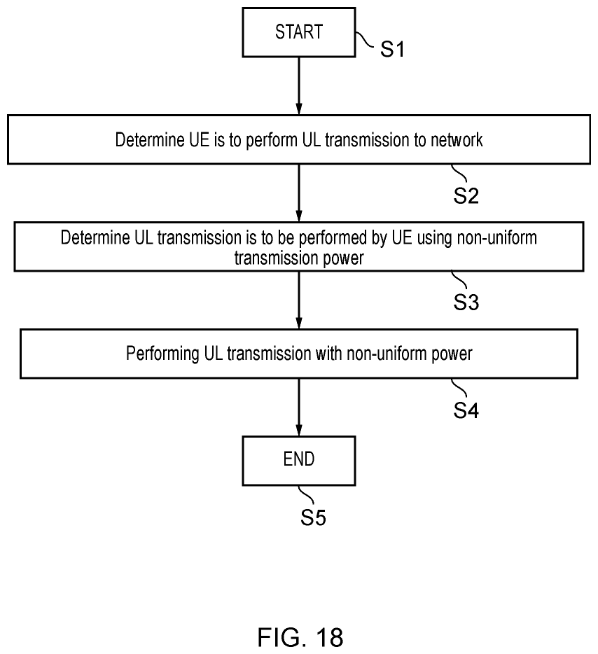

FIG. 18 shows a flow diagram illustrating a second example process of communications in a communications system in accordance with embodiments of the present technique. The process shown by FIG. 18 is a method of operating a communications device configured to transmit signals to and/or to receive signals from a wireless communications network via a wireless radio interface provided by the wireless communications network (e.g. to or from an infrastructure equipment of the wireless communications network).

The method begins in step S1. The method comprises, in step S2, determining that the communications device is to perform an uplink transmission to the wireless communications network within an allocated set of uplink resources of the wireless radio interface. In step S3, the process comprises determining that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources. The method then comprises, in step S4, performing the uplink transmission to the wireless communications network within the set of uplink resources in accordance with the non-uniform transmission power. The process ends in step S5.

Those skilled in the art would appreciate that the method shown by FIG. 18 may be adapted in accordance with embodiments of the present technique. For example, other intermediate steps may be included in this method, or the steps may be performed in any logical order. Furthermore, though embodiments of the present technique have been described largely by way of the example communications system shown in FIG. 11, and described further by way of the example arrangements of FIGS. 12 to 17, it would be clear to those skilled in the art that they could be equally applied to other systems to those described herein.

While it has been described generally in at least some arrangements of embodiments of the present technique that a UE/communications device is configured to selectively perform the non-uniform power control on uplink transmissions when and how it is configured (e.g. by a non-uniform power control indicator which indicates a certain power control function) to do so by a gNB/infrastructure equipment, those skilled in the art would appreciate that in at least some arrangements of embodiments of the present technique that a UE/communications device may be able to determine whether or not to apply and/or the configuration of how to apply the non-uniform power control independently or semi-independently. For example, the UE may detect (or be informed of) a time-overlapping (uplink or downlink) transmission to or from another UE in an adjacent sub-band to the sub-band in which it is to perform its UL transmission, and thus apply the power control independently. Should the UE determine (e.g. based on receiving the uniform power control indicator) that it is to apply the non-uniform power control, it may do so on the basis of a power control function it has previously used, or is defined in the specifications, or on the basis of simply reducing the UL transmission power in N frequency resource units from the edge of the sub-band, where N may be variable, fixed, independently determined by the UE, or dynamically/semi-statically indicated to the UE.

While embodiments of the present technique have been primarily described with respect to the application of non-uniform power control by a UE/communications device (based on either its own independent or semi-independent operation or on instruction from a gNB/infrastructure equipment) on uplink transmissions, those skilled in the art would appreciate that such embodiments of the present technique could similarly and correspondingly find application for the use of non-uniform power control for downlink transmissions by a gNB/infrastructure equipment. That is, embodiments of the present disclosure may also provide an infrastructure equipment forming part of a wireless communications network configured to transmit signals to and/or to receive signals from a communications device, the infrastructure equipment comprising transceiver circuitry configured to transmit signals and receive signals via a wireless radio interface provided by the infrastructure equipment, and controller circuitry. The controller circuitry is configured in combination with the transceiver circuitry to determine that the infrastructure equipment is to perform a downlink transmission to the communications device within a set of downlink resources of the wireless radio interface, to determine that the infrastructure equipment is to perform the downlink transmission within the set of downlink resources in accordance with a non-uniform transmission power, the non-uniform transmission power being non-uniform across the set of downlink resources and comprising at least a first transmission power to be used for transmitting signals representing the downlink transmission in a first portion of the set of downlink resources and a second transmission power, different to the first transmission power, to be used for transmitting signals representing the downlink transmission in a second portion of the set of downlink resources, and to perform the downlink transmission to the communications device within the set of downlink resources in accordance with the non-uniform transmission power.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may, without departing from the scope of the claims, form part of communications systems other than those defined by the present disclosure.

The following numbered paragraphs provide further example aspects and features of the present technique:

Paragraph 1. A method of operating a communications device configured to transmit signals to and/or to receive signals from a wireless communications network via a wireless radio interface provided by the wireless communications network, the method comprising
determining that the communications device is to perform an uplink transmission to the wireless communications network within an allocated set of uplink resources of the wireless radio interface,
determining that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
performing the uplink transmission to the wireless communications network within the set of uplink resources in accordance with the non-uniform transmission power.

Paragraph 2. A method according to Paragraph 1, wherein the first transmission power is lower than the second transmission power, and wherein the first portion of the set of uplink resources comprises one or more frequency resource units located at a first edge of the set of uplink resources and the second portion of the set of uplink resources comprises one or more frequency resource units located away from the first edge of the set of uplink resources.

Paragraph 3. A method according to Paragraph 2, wherein the first edge of the set of uplink resources is adjacent in frequency to a second set of resources of the wireless radio interface, the set of uplink resources and the second set of resources at least partially overlapping in time.

Paragraph 4. A method according to Paragraph 3, wherein the second set of resources is a set of downlink resources of the wireless access interface which is allocated to a second communications device for receiving a downlink signal from a same infrastructure equipment of the wireless communications network as is the target of the uplink transmission from the communications device, and wherein the transmission of the downlink signal at the infrastructure equipment at least partially overlaps in time with the reception of the uplink transmission at the infrastructure equipment.

Paragraph 5. A method according to Paragraph 3 or Paragraph 4, wherein a third set of resources is located in frequency between the second set of resources and the set of uplink resources, wherein the third set of resources acts as a guard frequency band.

Paragraph 6. A method according to any of Paragraphs 1 to 5, wherein the non-uniform transmission power is determined by the communications device based on a power control function selected by the communications device from among one or more power control functions.

Paragraph 7. A method according to Paragraph 6, wherein the selected power control function is selected by the communications device from among the one or more power control functions based on the communications device receiving an indication of the selected power control function from the wireless communications network.

Paragraph 8. A method according to Paragraph 6 or Paragraph 7, wherein the one or more power control functions are each defined as relative to a reference power known to the communications device.

Paragraph 9. A method according to Paragraph 8, wherein the reference power is associated with a known uplink power control function which is defined in the 3GPP specifications.

Paragraph 10. A method according to any of Paragraphs 6 to 9, wherein the one or more power control functions each define, for a range of frequencies, a power level which is to be applied to a frequency resource unit within that range of frequencies.

Paragraph 11. A method according to Paragraph 10, wherein the frequency resource units are resource blocks.

Paragraph 12. A method according to Paragraph 10 or Paragraph 11, wherein the frequency resource units are subcarriers.

Paragraph 13. A method according to any of Paragraphs 6 to 12, wherein each of the one or more power control functions are associated with one of a plurality of frequency-divided sub-bands of the wireless radio interface, and wherein the selected power control function is selected by the communications device from among the one or more power control functions based on the one of the plurality of sub-bands which comprises the allocated set of uplink resources.

Paragraph 14. A method according to Paragraph 13, wherein the associations between the one or more power control functions and the associated sub-band is determined by the communications device based on radio resource control, RRC, signalling received from the wireless communications network.

Paragraph 15. A method according to Paragraph 13 or Paragraph 14, wherein more than one of the power control functions are associated with a same one of the plurality of sub-bands.

Paragraph 16. A method according to Paragraph 15, wherein more than one of the power control functions are associated with the one of the plurality of sub-bands which comprises the allocated set of uplink resources, and wherein the selected power control function is selected by the communications device from among the more than one of the power control functions which are associated with the one of the plurality of sub-bands which comprises the allocated set of uplink resources based on the communications device receiving an indication of the selected power control function from the wireless communications network.

Paragraph 17. A method according to any of Paragraphs 6 to 16, wherein each of the one or more power control functions are associated with one of a plurality of sets of uplink resources of the wireless radio interface, and wherein the selected power control function is selected by the communications device from among the one or more power control functions based on the allocated set of uplink resources.

Paragraph 18. A method according to any of Paragraphs 6 to 17, wherein each of the one or more power control functions are associated with one of a plurality of uplink transmissions to the wireless communications network, and wherein the selected power control function is selected by the communications device from among the one or more power control functions based on an indication received by the communications device from the wireless communications network specifically for the uplink transmission performed by the communications device.

Paragraph 19. A method according to Paragraph 17 or Paragraph 18, wherein the associations between the one or more power control functions and the associated set of uplink resources is determined by the communications device based on RRC signalling received from the wireless communications network.

Paragraph 20. A method according to any of Paragraphs 17 to 19, wherein more than one of the power control functions are associated with a same one of the plurality of sets of uplink resources.

Paragraph 21. A method according to Paragraph 20, wherein more than one of the power control functions are associated with the allocated set of uplink resources, and wherein the selected power control function is selected by the communications device from among the more than one of the power control functions which are associated with the allocated set of uplink resources based on the communications device receiving an indication of the selected power control function from the wireless communications network.

Paragraph 22. A method according to any of Paragraphs 1 to 21, comprising
receiving, from the wireless communications network, a non-uniform power control indicator,
wherein the determining that the communications device is to perform the uplink transmission within the set of uplink resources in accordance with the non-uniform transmission power is based on determining that the non-uniform power control indicator indicates that the communications device is to perform the uplink transmission within the set of uplink resources in accordance with the non-uniform transmission power.

Paragraph 23. A method according to Paragraph 22, the non-uniform transmission power is determined by the communications device based on a power control function indicated by the non-uniform power control indicator from among a plurality of power control functions.

Paragraph 24. A method according to Paragraph 23, wherein the plurality of power control functions are indicated in RRC signalling received by the communications device from the wireless communications network, wherein the non-uniform power control indicator indicates one of the power control functions from among the plurality of power control functions indicated by the RRC signalling for use by the communications device.

Paragraph 25. A method according to any of Paragraphs 22 to 24, wherein the non-uniform power control indicator defines the non-uniform transmission power.

Paragraph 26. A method according to any of Paragraphs 22 to 25, wherein the non-uniform power control indicator is received by the communications device within downlink control information, DCI, transmitted by the wireless communications network.

Paragraph 27. A method according to Paragraph 26, wherein the DCI is an uplink grant and/or a downlink grant, the uplink grant and/or the downlink grant allocating the set of uplink resources in which the communications device is to perform the uplink transmission.

Paragraph 28. A method according to Paragraph 26 or Paragraph 27, wherein the DCI is an activation DCI that indicates that at least one instance of a set of grant-free resources is either activated or deactivated, the set of grant-free resources being the allocated set of uplink resources in which the communications device is to perform the uplink transmission to the wireless communications network in a grant-free manner.

Paragraph 29. A method according to Paragraph 28, wherein the non-uniform power control indicator indicates that the communications device is to perform the uplink transmission within only one or more first instances of the set of grant-free resources in accordance with the non-uniform transmission power.

Paragraph 30. A method according to any of Paragraphs 26 to 29, wherein the DCI is a group common DCI, GC-DCI, transmitted by the wireless communications network to one or more other communications devices in addition to the communications device.

Paragraph 31. A method according to Paragraph 30, wherein the GC-DCI indicates one or more of a plurality of frequency-divided sub-bands of the wireless radio interface for which the non-uniform transmission power is to be applied, and Paragraph wherein the performing the uplink transmission to the wireless communications network within the set of uplink resources in accordance with the non-uniform transmission power is based on the set of uplink resources being within one of the sub-bands for which the GC-DCI indicates the non-uniform transmission power is to be applied.

Paragraph 32. A method according to Paragraph 30 or Paragraph 31, wherein the GC-DCI is associated with one of a plurality of frequency-divided sub-bands of the wireless radio interface and indicates, for that associated sub-band, one or more of a plurality of time-divided slots of the wireless radio interface for which the non-uniform transmission power is to be applied, and
wherein the performing the uplink transmission to the wireless communications network within the set of uplink resources in accordance with the non-uniform transmission power is based on the set of uplink resources being within the sub-band associated with the GC-DCI and within one of the slots, indicated by the GC-DCI, for which the non-uniform transmission power is to be applied.

Paragraph 33. A method according to any of Paragraphs 30 to 32, wherein the GC-DCI indicates a two-dimensional bitmap, the GC-DCI indicating, in a first dimension of the bitmap, one or more of a plurality of frequency-divided sub-bands of the wireless radio interface for which the non-uniform transmission power is to be applied, and the GC-DCI indicating, in a second dimension of the bitmap, one or more of a plurality of time-divided slots of the wireless radio interface for which the non-uniform transmission power is to be applied, and
wherein the performing the uplink transmission to the wireless communications network within the set of uplink resources in accordance with the non-uniform transmission power is based on the set of uplink resources being within one of the sub-bands, indicated by the GC-DCI, for which the non-uniform transmission power is to be applied and within one of the slots, indicated by the GC-DCI, for which the non-uniform transmission power is to be applied.

Paragraph 34. A method according to any of Paragraphs 30 to 33, comprising
RRC signalling from the wireless communications network, the RRC signalling indicating an association between the GC-DCI and one of a plurality of frequency-divided sub-bands of the wireless radio interface.

Paragraph 35. A method according to any of Paragraphs 22 to 34, wherein the non-uniform power control indicator is received by the communications device via RRC signalling from the wireless communications network.

Paragraph 36. A communications device configured to transmit signals to and/or to receive signals from a wireless communications network, the communications device comprising
transceiver circuitry configured to transmit signals and receive signals via a wireless radio interface provided by the wireless communications network, and
controller circuitry configured in combination with the transceiver circuitry
to determine that the communications device is to perform an uplink transmission to the wireless communications network within an allocated set of uplink resources of the wireless radio interface,
to determine that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
to perform the uplink transmission to the wireless communications network within the set of uplink resources in accordance with the non-uniform transmission power.

Paragraph 37. Circuitry for a communications device configured to transmit signals to and/or to receive signals from a wireless communications network, the communications device comprising
transceiver circuitry configured to transmit signals and receive signals via a wireless radio interface provided by the wireless communications network, and
controller circuitry configured in combination with the transceiver circuitry
to determine that the communications device is to perform an uplink transmission to the wireless communications network within an allocated set of uplink resources of the wireless radio interface,
to determine that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
to perform the uplink transmission to the wireless communications network within the set of uplink resources in accordance with the non-uniform transmission power.

Paragraph 38. A method of operating an infrastructure equipment forming part of a wireless communications network configured to transmit signals to and/or to receive signals from a communications device via a wireless radio interface provided by the infrastructure equipment, the method comprising
determining that the infrastructure equipment is to receive an uplink transmission from the communications device within an allocated set of uplink resources of the wireless radio interface,
determining that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
receiving the uplink transmission from the communications device within the set of uplink resources in accordance with the non-uniform transmission power.

Paragraph 39. A method according to Paragraph 38, wherein the first transmission power is lower than the second transmission power, and wherein the first portion of the set of uplink resources comprises one or more frequency resource units located at a first edge of the set of uplink resources and the second portion of the set of uplink resources comprises one or more frequency resource units located away from the first edge of the set of uplink resources.

Paragraph 40. A method according to Paragraph 39, wherein the first edge of the set of uplink resources is adjacent in frequency to a second set of resources of the wireless radio interface, the set of uplink resources and the second set of resources at least partially overlapping in time.

Paragraph 41. A method according to Paragraph 40, wherein the second set of resources is a set of downlink resources of the wireless access interface which is allocated to a second communications device for receiving a downlink signal transmitting by the infrastructure equipment, and wherein the transmission of the downlink signal at the infrastructure equipment at least partially overlaps in time with the reception of the uplink transmission at the infrastructure equipment.

Paragraph 42. A method according to Paragraph 40 or Paragraph 41, wherein a third set of resources is located in frequency between the second set of resources and the set of uplink resources, wherein the third set of resources acts as a guard frequency band.

Paragraph 43. A method according to any of Paragraphs 38 to 42, comprising
configuring one or more power control functions for use by the communications device, wherein the non-uniform transmission power is determined by the communications device based on a power control function selected by the communications device from among the one or more configured power control functions.

Paragraph 44. A method according to Paragraph 43, comprising
transmitting, to the communications device, an indication of the selected power control function, wherein the selected power control function is selected by the communications device from among the one or more configured power control functions based on the indication.

Paragraph 45. A method according to Paragraph 43 or Paragraph 44, wherein the one or more configured power control functions are each defined as relative to a reference power known to the communications device.

Paragraph 46. A method according to Paragraph 45, wherein the reference power is associated with a known uplink power control function which is defined in the 3GPP specifications.

Paragraph 47. A method according to any of Paragraphs 43 to 46, wherein the one or more configured power control functions each define, for a range of frequencies, a power level which is to be applied to a frequency resource unit within that range of frequencies.

Paragraph 48. A method according to Paragraph 47, wherein the frequency resource units are resource blocks.

Paragraph 49. A method according to any of Paragraphs 45 to 48, wherein the frequency resource units are subcarriers.

Paragraph 50. A method according to any of Paragraphs 43 to 49, wherein each of the one or more configured power control functions are associated with one of a plurality of frequency-divided sub-bands of the wireless radio interface, and wherein the selected power control function is selected by the communications device from among the one or more configured power control functions based on the one of the plurality of sub-bands which comprises the allocated set of uplink resources.

Paragraph 51. A method according to Paragraph 50, comprising
transmitting, to the communications device, radio resource control, RRC, signalling comprising an indication of the associations between the one or more configured power control functions and the associated sub-band.

Paragraph 52. A method according to Paragraph 50 or Paragraph 51, wherein more than one of the configured power control functions are associated with a same one of the plurality of sub-bands.

Paragraph 53. A method according to Paragraph 52, wherein more than one of the configured power control functions are associated with the one of the plurality of sub-bands which comprises the allocated set of uplink resources, and wherein the method comprises
transmitting, to the communications device, an indication of the selected power control function, wherein the selected power control function is selected by the communications device from among the more than one of the configured power control functions which are associated with the one of the plurality of sub-bands which comprises the allocated set of uplink resources based on the indication.

Paragraph 54. A method according to any of Paragraphs 43 to 53, wherein each of the one or more configured power control functions are associated with one of a plurality of sets of uplink resources of the wireless radio interface, and wherein the selected power control function is selected by the communications device from among the one or more configured power control functions based on the allocated set of uplink resources.

Paragraph 55. A method according to any of Paragraphs 43 to 54, wherein each of the one or more configured power control functions are associated with one of a plurality of uplink transmissions, and wherein the method comprises
transmitting, to the communications device, an indication of the selected power control function specifically for the uplink transmission performed by the communications device.

Paragraph 56. A method according to Paragraph 54 or Paragraph 55, comprising
transmitting, to the communications device, RRC signalling comprising an indication of the associations between the one or more configured power control functions and the associated set of uplink resources.

Paragraph 57. A method according to any of Paragraphs 54 to 56, wherein more than one of the configured power control functions are associated with a same one of the plurality of sets of uplink resources.

Paragraph 58. A method according to Paragraph 57, wherein more than one of the configured power control functions are associated with the allocated set of uplink resources, and wherein the method comprises
transmitting, to the communications device, an indication of the selected power control function, wherein the selected power control function is selected by the communications device from among the more than one of the configured power control functions which are associated with the allocated set of uplink resources based on the indication.

Paragraph 59. A method according to any of Paragraphs 38 to 58, comprising
transmitting, to the communications device, a non-uniform power control indicator, the non-uniform power control indicator indicating that the communications device is to perform the uplink transmission within the set of uplink resources in accordance with the non-uniform transmission power,
wherein the determining that the communications device is to perform the uplink transmission within the set of uplink resources in accordance with the non-uniform transmission power is based on transmitting the non-uniform power control indicator to the communications device.

Paragraph 60. A method according to Paragraph 59, comprising
configuring a plurality of power control functions for use by the communications device, wherein the non-uniform transmission power is determined by the communications device based on a power control function indicated by the non-uniform power control indicator from among the plurality of configured power control functions.

Paragraph 61. A method according to Paragraph 60, comprising
transmitting, to the communications device, RRC signalling comprising the configuration of the plurality of configured power control functions, wherein the non-uniform power control indicator indicates one of the power control functions from among the plurality of power control functions indicated by the RRC signalling for use by the communications device.

Paragraph 62. A method according to any of Paragraphs 59 to 61, wherein the non-uniform power control indicator defines the non-uniform transmission power.

Paragraph 63. A method according to any of Paragraphs 59 to 62, comprising
transmitting, to the communications device, downlink control information, DCI, comprising the non-uniform power control indicator.

Paragraph 64. A method according to Paragraph 63, wherein the DCI is an uplink grant and/or a downlink grant, the uplink grant and/or the downlink grant allocating the set of uplink resources in which the communications device is to perform the uplink transmission.

Paragraph 65. A method according to Paragraph 63 or Paragraph 64, wherein the DCI is an activation DCI that indicates that at least one instance of a set of grant-free resources is either activated or deactivated, the set of grant-free resources being the allocated set of uplink resources in which the communications device is to perform the uplink transmission to the infrastructure equipment in a grant-free manner.

Paragraph 66. A method according to Paragraph 65, wherein the non-uniform power control indicator indicates that the communications device is to perform the uplink transmission within only one or more first instances of the set of grant-free resources in accordance with the non-uniform transmission power.

Paragraph 67. A method according to any of Paragraphs 63 to 66, wherein the DCI is a group common DCI, GC-DCI, transmitted by the infrastructure equipment to one or more other communications devices in addition to the communications device.

Paragraph 68. A method according to Paragraph 67, wherein the GC-DCI indicates one or more of a plurality of frequency-divided sub-bands of the wireless radio interface for which the non-uniform transmission power is to be applied, and
wherein the receiving the uplink transmission from the communications device within the set of uplink resources in accordance with the non-uniform transmission power is based on the set of uplink resources being within one of the sub-bands for which the GC-DCI indicates the non-uniform transmission power is to be applied.

Paragraph 69. A method according to Paragraph 67 or Paragraph 68, wherein the GC-DCI is associated with one of a plurality of frequency-divided sub-bands of the wireless radio interface and indicates, for that associated sub-band, one or more of a plurality of time-divided slots of the wireless radio interface for which the non-uniform transmission power is to be applied, and
wherein the receiving the uplink transmission from the communications device within the set of uplink resources in accordance with the non-uniform transmission power is based on the set of uplink resources being within the sub-band associated with the GC-DCI and within one of the slots, indicated by the GC-DCI, for which the non-uniform transmission power is to be applied.

Paragraph 70. A method according to any of Paragraphs 67 to 69, wherein the GC-DCI indicates a two-dimensional bitmap, the GC-DCI indicating, in a first dimension of the bitmap, one or more of a plurality of frequency-divided sub-bands of the wireless radio interface for which the non-uniform transmission power is to be applied, and the GC-DCI indicating, in a second dimension of the bitmap, one or more of a plurality of time-divided slots of the wireless radio interface for which the non-uniform transmission power is to be applied, and
wherein the receiving the uplink transmission from the communications device within the set of uplink resources in accordance with the non-uniform transmission power is based on the set of uplink resources being within one of the sub-bands, indicated by the GC-DCI, for which the non-uniform transmission power is to be applied and within one of the slots, indicated by the GC-DCI, for which the non-uniform transmission power is to be applied.

Paragraph 71. A method according to any of Paragraphs 67 to 70, comprising
transmitting RRC signalling to the communications device, the RRC signalling indicating an association between the GC-DCI and one of a plurality of frequency-divided sub-bands of the wireless radio interface.

Paragraph 72. A method according to any of Paragraphs 59 to 71, comprising
transmitting RRC signalling to the communications device, the RRC signalling comprising the non-uniform power control indicator.

Paragraph 73. An infrastructure equipment forming part of a wireless communications network configured to transmit signals to and/or to receive signals from a communications device, the infrastructure equipment comprising
transceiver circuitry configured to transmit signals and receive signals via a wireless radio interface provided by the infrastructure equipment, and
controller circuitry configured in combination with the transceiver circuitry
to determine that the infrastructure equipment is to receive an uplink transmission from the communications device within an allocated set of uplink resources of the wireless radio interface,
to determine that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
to receive the uplink transmission from the communications device within the set of uplink resources in accordance with the non-uniform transmission power.

Paragraph 74. Circuitry for an infrastructure equipment forming part of a wireless communications network configured to transmit signals to and/or to receive signals from a communications device, the infrastructure equipment comprising
transceiver circuitry configured to transmit signals and receive signals via a wireless radio interface provided by the infrastructure equipment, and controller circuitry configured in combination with the transceiver circuitry
to determine that the infrastructure equipment is to receive an uplink transmission from the communications device within an allocated set of uplink resources of the wireless radio interface,
to determine that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
to receive the uplink transmission from the communications device within the set of uplink resources in accordance with the non-uniform transmission power.

Paragraph 75. A method of operating an infrastructure equipment forming part of a wireless communications network configured to transmit signals to and/or to receive signals from a communications device via a wireless radio interface provided by the infrastructure equipment, the method comprising
determining that the infrastructure equipment is to perform a downlink transmission to the communications device within a set of downlink resources of the wireless radio interface,
determining that the infrastructure equipment is to perform the downlink transmission within the set of downlink resources in accordance with a non-uniform transmission power, the non-uniform transmission power being non-uniform across the set of downlink resources and comprising at least a first transmission power to be used for transmitting signals representing the downlink transmission in a first portion of the set of downlink resources and a second transmission power, different to the first transmission power, to be used for transmitting signals representing the downlink transmission in a second portion of the set of downlink resources, and
performing the downlink transmission to the communications device within the set of downlink resources in accordance with the non-uniform transmission power.

Paragraph 76. An infrastructure equipment forming part of a wireless communications network configured to transmit signals to and/or to receive signals from a communications device, the infrastructure equipment comprising
transceiver circuitry configured to transmit signals and receive signals via a wireless radio interface provided by the infrastructure equipment, and controller circuitry configured in combination with the transceiver circuitry
to determine that the infrastructure equipment is to perform a downlink transmission to the communications device within a set of downlink resources of the wireless radio interface,
to determine that the infrastructure equipment is to perform the downlink transmission within the set of downlink resources in accordance with a non-uniform transmission power, the non-uniform transmission power being non-uniform across the set of downlink resources and comprising at least a first transmission power to be used for transmitting signals representing the downlink transmission in a first portion of the set of downlink resources and a second transmission power, different to the first transmission power, to be used for transmitting signals representing the downlink transmission in a second portion of the set of downlink resources, and
to perform the downlink transmission to the communications device within the set of downlink resources in accordance with the non-uniform transmission power.

Paragraph 77. Circuitry for an infrastructure equipment forming part of a wireless communications network configured to transmit signals to and/or to receive signals from a communications device, the infrastructure equipment comprising
transceiver circuitry configured to transmit signals and receive signals via a wireless radio interface provided by the infrastructure equipment, and controller circuitry configured in combination with the transceiver circuitry
to determine that the infrastructure equipment is to perform a downlink transmission to the communications device within a set of downlink resources of the wireless radio interface,
to determine that the infrastructure equipment is to perform the downlink transmission within the set of downlink resources in accordance with a non-uniform transmission power, the non-uniform transmission power being non-uniform across the set of downlink resources and comprising at least a first transmission power to be used for transmitting signals representing the downlink transmission in a first portion of the set of downlink resources and a second transmission power, different to the first transmission power, to be used for transmitting signals representing the downlink transmission in a second portion of the set of downlink resources, and
to perform the downlink transmission to the communications device within the set of downlink resources in accordance with the non-uniform transmission power.

Paragraph 78. A telecommunications system comprising a communications device according to Paragraph 36 and an infrastructure equipment according to Paragraph 73.

Paragraph 79. A computer program comprising instructions which, when loaded onto a computer, cause the computer to perform a method according to any of Paragraphs 1 to 35, Paragraphs 38 to 72, or Paragraph 75.

Paragraph 80. A non-transitory computer-readable storage medium storing a computer program according to Paragraph 79.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-192330, “New work item: 2-step RACH for NR,” ZTE Corporation, 3GPP TSG RAN Meeting #85.
[3] RP-192324, “Revised WID: Support of NR Industrial Internet of Things (IoT),” Nokia, Nokia Shanghai Bell, 3GPP TSG RAN Meeting #85.
[4] RP-191575, “NR-based Access to Unlicensed Spectrum,” Qualcomm, Inc., 3GPP TSG RAN Meeting #84.
[5] RP-220633, “Revised SID: Study on evolution of NR duplex operation,” CMCC, RAN #95-e.
[6] TS38.213, “Physical layer procedures for control (Release 17)”.
[7] European patent No. 3545716.

1. A method of operating a communications device configured to transmit signals to and/or to receive signals from a wireless communications network via a wireless radio interface provided by the wireless communications network, the method comprising
determining that the communications device is to perform an uplink transmission to the wireless communications network within an allocated set of uplink resources of the wireless radio interface,
determining that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
performing the uplink transmission to the wireless communications network within the set of uplink resources in accordance with the non-uniform transmission power.

2. A method according to claim 1, wherein the first transmission power is lower than the second transmission power, and wherein the first portion of the set of uplink resources comprises one or more frequency resource units located at a first edge of the set of uplink resources and the second portion of the set of uplink resources comprises one or more frequency resource units located away from the first edge of the set of uplink resources.

3. A method according to claim 2, wherein the first edge of the set of uplink resources is adjacent in frequency to a second set of resources of the wireless radio interface, the set of uplink resources and the second set of resources at least partially overlapping in time.

4. A method according to claim 3, wherein the second set of resources is a set of downlink resources of the wireless access interface which is allocated to a second communications device for receiving a downlink signal from a same infrastructure equipment of the wireless communications network as is the target of the uplink transmission from the communications device, and wherein the transmission of the downlink signal at the infrastructure equipment at least partially overlaps in time with the reception of the uplink transmission at the infrastructure equipment.

5. A method according to claim 3, wherein a third set of resources is located in frequency between the second set of resources and the set of uplink resources, wherein the third set of resources acts as a guard frequency band.

6. A method according to claim 1, wherein the non-uniform transmission power is determined by the communications device based on a power control function selected by the communications device from among one or more power control functions.

7. A method according to claim 6, wherein the selected power control function is selected by the communications device from among the one or more power control functions based on the communications device receiving an indication of the selected power control function from the wireless communications network.

8. A method according to claim 6, wherein the one or more power control functions are each defined as relative to a reference power known to the communications device.

9. A method according to claim 8, wherein the reference power is associated with a known uplink power control function which is defined in the 3GPP specifications.

10. A method according to claim 6, wherein the one or more power control functions each define, for a range of frequencies, a power level which is to be applied to a frequency resource unit within that range of frequencies.

11. A method according to claim 10, wherein the frequency resource units are resource blocks.

12. A method according to claim 10, wherein the frequency resource units are subcarriers.

13. A method according to claim 6, wherein each of the one or more power control functions are associated with one of a plurality of frequency-divided sub-bands of the wireless radio interface, and wherein the selected power control function is selected by the communications device from among the one or more power control functions based on the one of the plurality of sub-bands which comprises the allocated set of uplink resources.

14. A method according to claim 13, wherein the associations between the one or more power control functions and the associated sub-band is determined by the communications device based on radio resource control, RRC, signalling received from the wireless communications network.

15. A method according to claim 13, wherein more than one of the power control functions are associated with a same one of the plurality of sub-bands.

16. A method according to claim 15, wherein more than one of the power control functions are associated with the one of the plurality of sub-bands which comprises the allocated set of uplink resources, and wherein the selected power control function is selected by the communications device from among the more than one of the power control functions which are associated with the one of the plurality of sub-bands which comprises the allocated set of uplink resources based on the communications device receiving an indication of the selected power control function from the wireless communications network.

17. A method according to claim 6, wherein each of the one or more power control functions are associated with one of a plurality of sets of uplink resources of the wireless radio interface, and wherein the selected power control function is selected by the communications device from among the one or more power control functions based on the allocated set of uplink resources.

18. A method according to claim 6, wherein each of the one or more power control functions are associated with one of a plurality of uplink transmissions to the wireless communications network, and wherein the selected power control function is selected by the communications device from among the one or more power control functions based on an indication received by the communications device from the wireless communications network specifically for the uplink transmission performed by the communications device.

19.-35. (canceled)

36. A communications device configured to transmit signals to and/or to receive signals from a wireless communications network, the communications device comprising
transceiver circuitry configured to transmit signals and receive signals via a wireless radio interface provided by the wireless communications network, and
controller circuitry configured in combination with the transceiver circuitry
to determine that the communications device is to perform an uplink transmission to the wireless communications network within an allocated set of uplink resources of the wireless radio interface,
to determine that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
to perform the uplink transmission to the wireless communications network within the set of uplink resources in accordance with the non-uniform transmission power.

37.-72. (canceled)

73. An infrastructure equipment forming part of a wireless communications network configured to transmit signals to and/or to receive signals from a communications device, the infrastructure equipment comprising
transceiver circuitry configured to transmit signals and receive signals via a wireless radio interface provided by the infrastructure equipment, and
controller circuitry configured in combination with the transceiver circuitry
to determine that the infrastructure equipment is to receive an uplink transmission from the communications device within an allocated set of uplink resources of the wireless radio interface,
to determine that the communications device is to perform the uplink transmission within the set of uplink resources in accordance with a non-uniform transmission power, the non-uniform transmission power being non-uniform across the set of uplink resources and comprising at least a first transmission power to be used for transmitting signals representing the uplink transmission in a first portion of the set of uplink resources and a second transmission power, different to the first transmission power, to be used for transmitting signals representing the uplink transmission in a second portion of the set of uplink resources, and
to receive the uplink transmission from the communications device within the set of uplink resources in accordance with the non-uniform transmission power.

74.-80. (canceled)
